(19) United States
(12) Patent Application Publication
(10) Pub. No.: US 2018/0108230 A1
(43) Pub. Date: Apr. 19, 2018

(54) MONITORING OF LEGACY CONTROLS IN SMART HOME SYSTEM

(71) Applicant: Switchmate Home LLC, Pleasanton, CA (US)

(72) Inventor: Dean Finnegan, Pleasanton, CA (US)

(21) Appl. No.: 15/846,080

(22) Filed: Dec. 18, 2017

Related U.S. Application Data
(63) Continuation-in-part of application No. 15/368,573, filed on Dec. 3, 2016.
Application No. 15/368,573 is a continuation-in-part of application No. 15/236,482, filed on Aug. 15, 2016, now Pat. No. 9,520,247.
Application No. 15/236,482 is a continuation-in-part of application No. 14/617,020, filed on Feb. 9, 2015, now Pat. No. 9,418,802.
(60) Provisional application No. 62/424,467, filed on Nov. 20, 2016.
(60) Provisional application No. 61/937,493, filed on Feb. 8, 2014.
(60) Provisional application No. 62/065,564, filed on Oct. 17, 2014.

(51) Int. Cl. G08B 13/196; H04L 12/28

(52) U.S. Cl. CPC G08B 13/19695; H04L 2012/2841; H04L 12/2823

(57) ABSTRACT

Detection of user operation of legacy controls and devices, and incorporation of user intention inferred therefrom as input to a smart home system and/or smart home devices.

This application is a continuation-in-part of U.S. application Ser. No. 15/368,573 filed Dec. 3, 2016, currently pending, which is a continuation-in-part of U.S. application Ser. No. 15/236,482 filed Aug. 15, 2016, issued as U.S. Pat. No. 9,520,247 on Dec. 13, 2016, which is a continuation-in-part of U.S. application Ser. No. 14/617,020, filed Feb. 9, 2015, issued as U.S. Pat. No. 9,418,802 on Aug. 16, 2016, which claims priority from U.S. Provisional Patent Application No. 61/937,493, filed Feb. 8, 2014, and from U.S. Provisional Patent Application No. 62/065,564, filed Oct. 17, 2014; U.S. application Ser. No. 15/368,573 also claims priority from U.S. Provisional Patent Application No. 62/424,467 filed Nov. 20, 2016; this application claims priority from and benefit of each of the applications enumerated in this paragraph, each of which is incorporated herein by reference in its entirety.

### BACKGROUND

Many consumers who desire the convenience of a smart home system are excluded from the benefits of this technology because available systems require replacing existing “legacy” fixtures and controls with new devices. The obstacle is not merely the considerable expense involved in purchasing replacement fixtures and controls. Removing old switches, controls, and fixtures also inevitably causes damage to wall coverings and paint that must repaired, leaves holes that must be filled, requires connecting to worn or corroded electrical wires in boxes of the wrong size, disturbs old and finicky wiring or plumbing—in short, there is considerable potential for the expense and disruption to multiply. In many localities, expensive permits are required, which may trigger other required upgrades, and work must be performed by licensed contractors. Further, renters are typically forbidden by lease terms from making any changes, and even if given permission most tenants would be reluctant to pay for expensive improvements that would have to be left behind at the expiration of the lease.

Thus there exists a need for practicable smart home devices and systems that are readily installable and removable by consumers themselves, without alteration or damage to the existing electrical, plumbing, security, HVAC, and other systems of the home, and without requiring permission of landlords or regulatory authorities or needing specialized construction skills.

### SUMMARY

In general and by way of summary illustration only, disclosed herein are embodiments of devices, systems, and methods that facilitate the use of existing “legacy” controls and fixtures as inputs to a smart home and/or internet of things (“IoT”) ecosystem and/or as inputs to devices or components forming a part of such systems, without disturbing the existing installation and/or operation of the legacy controls or fixtures. In some embodiments, disclosed are devices, components, methods, and systems whereby a smart home and/or IoT system or device(s) and/or component(s) thereof is enabled to detect the operation of a legacy control or device by a user or other agent, and to infer and respond to the intention of the user as manifested by the user's operation of the legacy control or device.

An example embodiment relates to the familiar doorbell button found at the entrance to many homes. Replacing an existing conventional doorbell button with a new device adapted to communicate with a smart home system may be undesirable for the reasons already mentioned. It is impracticable to manufacture an “add-on” device that would mount over an existing doorbell button and actuate it directly, because of the very wide variety of button sizes, styles, and configurations that would have to be accommodated, and the variability of shapes and surfaces on which existing buttons are mounted. Disclosed herein are embodiments of a solution that leaves the structure, wiring, and functionality of the existing doorbell button undisturbed, and provides the smart home/IoT system with functionality to detect the action of a user operating the existing doorbell button, thereby in effect allowing the system to use the existing doorbell button as an additional input control, without the necessity of replacing it or making a physical or electrical connection. Thus, for example, when a visitor depresses the existing doorbell button, the existing door chimes operate as usual, but the smart home/IoT system or component(s) thereof may detect and interpret the visitor's movements in depressing the existing doorbell button, and, for example, respond by activating a camera so that the homeowner can observe the visitor, and/or activating an intercom device so that the homeowner can communicate with the visitor, and/or activating other appropriate functions of the smart home/IoT system.

Other embodiments are disclosed wherein other user actions may be detected and interpreted, such as, for example, the action of a user in operating a lock with a key, or operating a doorknob or latch. Thus, for example, when a user performs the actions required to unlock and/or open a door, the smart home/IoT system or component(s) thereof may detect and interpret the user's actions, and in response activate desired functions such as notifying another person, changing a thermostat setting, activating a camera, turning on lights, closing a garage door, activating an alarm, etc.

In general, disclosed herein are embodiments of smart home devices intended to allow users to influence and/or control the operation of a smart home system or IoT system and/or component(s) thereof via operation of existing “legacy” controls and/or devices, with minimal or no alteration or disturbance of the existing controls and/or devices, by detecting such operation via devices that are part of or in communication with the smart home or IoT system, and that optionally function wirelessly and remotely and whose installation and alignment are within the capabilities of the non-specialist homeowner.

In some embodiments, an object of the present disclosure is to detect and/or interpret the actions of users and/or other agents in operating existing “legacy” controls, fixtures, and/or devices so as to make a smart home system and/or component(s) thereof responsive to such actions without requiring alteration of or physical connection to the existing controls, fixtures, and/or devices.

In some embodiments, an object of the present disclosure is to provide devices and components for smart home/IoT systems that are capable of maintaining functionality over long periods of time with minimal or no maintenance and minimal power consumption.

In some embodiments, an object of the present disclosure is to provide smart home, smart home, IoT, workplace automation, and/or security products that enable first time consumers to experience the lifestyle improvements afforded thereby by requiring simple installation and minimal or no setup or programming for operability with a smart home ecosystem.

In some embodiments, an object of the present disclosure is to provide smart home, home automation, IoT, workplace automation, and/or security products that are remotely accessible and/or controllable.

In embodiments, an object of the present disclosure is to provide for installation of smart home systems and components without a need for specialized expertise and/or tools.

In embodiments, an object of the present disclosure is to provide for smart home systems and components within the capabilities of a typical homeowner or consumer to install.

In embodiments, an object of the present disclosure is to provide devices, methods, and systems for smart home systems and components that can be installed rapidly in their out-of-the-box configuration with minimal or no required alteration or preparation of the installation site.

In embodiments, an object of the present disclosure is to provide for installation of smart home systems and components capable of operating and/or obtaining input from controls and/or fixtures already present in the home ecosystem, without modification, removal, or disassembly of the controls and/or fixtures.

In embodiments, an object of the present disclosure is to provide for installation of smart home systems and components capable of operating and/or controlling and/or detecting user operation of standard electrical controls and devices, such as, for example, doorbell buttons, entry locks, doorknobs and latches, light switches, electrical receptacles, dimmers, motor controls, and environmental controls.

In embodiments, an object of the present disclosure is to provide for installation of smart home systems and components in a manner whereby the smart home devices are readily removable without damage and/or alteration to the existing controls or devices to which they are installed, and/or whereby upon such removal the existing controls or devices are substantially restored to their condition prior to the installation without further operation thereon.

In embodiments, an object of the present disclosure is to provide for installation of smart home systems and components in a manner whereby the smart home devices are readily removable and reinstallable in another location if desired.

In embodiments, an object of the present disclosure is to provide for rapid installation of smart home systems and components without exposing electrical wiring or other components carrying potentially dangerous electrical currents or potentials, and/or requiring minimal or no physical connection or interaction by the smart home systems or components with existing electrical, plumbing, security, HVAC, or other systems already present.

In some embodiments, an object of the present disclosure is to provide smart home devices, home automation devices, workplace automation devices, and/or security system devices having improved battery life and/or low power consumption.

In some embodiments, an object of the present disclosure is to provide smart home, home automation, IoT, workplace automation, and/or security system ecosystems having flexibility to interact with a variety of devices having a variety of functions, including legacy controls, devices, and fixtures.

In some embodiments, an object of the present disclosure is to provide smart home, home automation, IoT, workplace automation, and/or security system ecosystems adapted for simple integration and/or removal and/or replacement of devices by users without assistance.

In some embodiments, an object of the present disclosure is to provide control, sensing, communication, and other devices for incorporation in smart home, home automation, IoT, workplace automation, and/or security ecosystems.

In some embodiments, an object of the present disclosure is to provide control, sensing, communication, and other devices adapted to self-integrate with a smart home, home automation, IoT, workplace automation, and/or security ecosystems and/or to integrate therein with minimal user action required.

In some embodiments, an object of the present disclosure is to provide control, sensing, communication, and other devices compatible with ecosystems available currently and/or in the future, such as, for example, Alexa, Nest, Samsung Home, and Google Home.

It will be apparent to persons of skill in the art that various of the foregoing aspects and/or objects, and various other aspects and/or objects disclosed herein, can be incorporated and/or achieved separately or combined in a single device, method, system, composition, article of manufacture, and/or improvement thereof, thus obtaining the benefit of more than one aspect and/or object, and that an embodiment may encompass none, one, or more than one but less than all of the aspects, objects, or features enumerated in the foregoing summary or otherwise disclosed herein. The disclosure hereof extends to all such combinations. In addition to the illustrative aspects, embodiments, objects, and features described above, further aspects, embodiments, objects, and features will become apparent by reference to the drawing figures and detailed description. Also disclosed herein are various embodiments of related methods, devices, apparatus, compositions, systems, articles of manufacture, and/or improvements thereof. The foregoing summary is intended to provide a brief introduction to the subject matter of this disclosure and does not in any way limit or circumscribe the scope of the invention(s) disclosed herein, which scope is defined by the claims currently appended or as they may be amended, and as interpreted by a skilled artisan in the light of the entire disclosure.

### BRIEF DESCRIPTION OF THE FIGURES

FIG. 1A shows a schematic depiction of an example of the operation of an embodiment of a monitor adapted to detect user operation of a legacy doorbell control.

FIG. 1B depicts schematically the components of an embodiment of a monitor adapted to detect user operation of a legacy entry control.

FIG. 1C shows a schematic depiction of an example of the operation of an embodiment of a monitor adapted to detect user operation of a legacy doorknob or latch.

FIG. 1D shows a schematic depiction of an example of the operation of an embodiment of a monitor adapted to detect user operation of a legacy door lock.

FIG. 2A depicts components of an embodiment of a smart home system and their relationships.

FIG. 2B depicts components and their relationships in another embodiment of a smart home system including a legacy control monitor.

FIG. 3A shows a schematic depiction of an example of the operation of an embodiment of a monitor adapted to detect user operation of a legacy doorbell control, with integrated camera, speaker, and microphone.

FIG. 3B depicts schematically the components of an embodiment of a monitor adapted to detect user operation of a legacy entry control and including integrated camera, speaker, and microphone.

FIG. 4 depicts a sensing envelope of an embodiment of a monitor adapted to detect user operation of a legacy control.

Figures are not to scale unless expressly so labeled, and relative positions and/or orientations of objects and components are illustrative. Persons of skill in the art will recognize that many other arrangements, configurations, dimensions, and selections of components are possible and consistent with the disclosure hereof, and are in no way limited to the embodiments shown in the figures.

### DETAILED DESCRIPTION

Often present in the installed environment of a smart home system are legacy entry controls or devices, such as, for example, legacy doorbell buttons, door locks or locking devices, and doorknobs or door latches. Typically these may be “dumb” non-network-enabled devices, not adapted to communicate or interoperate with a smart home system. Disclosed herein are embodiments of novel methods, systems, devices, apparatus, compositions, articles of manufacture, and improvements thereof useful for providing a smart home/IoT system with functionality to be aware of and responsive to the operation by a user of existing legacy controls.

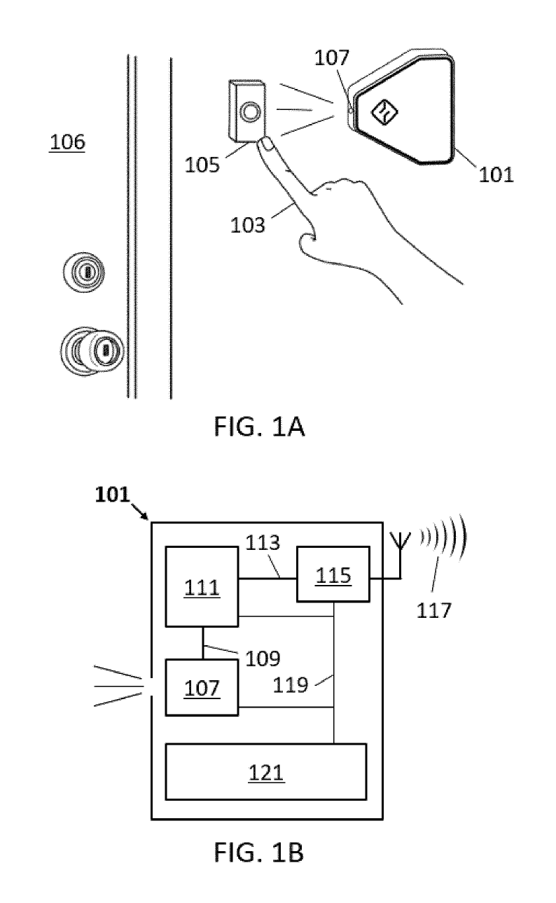

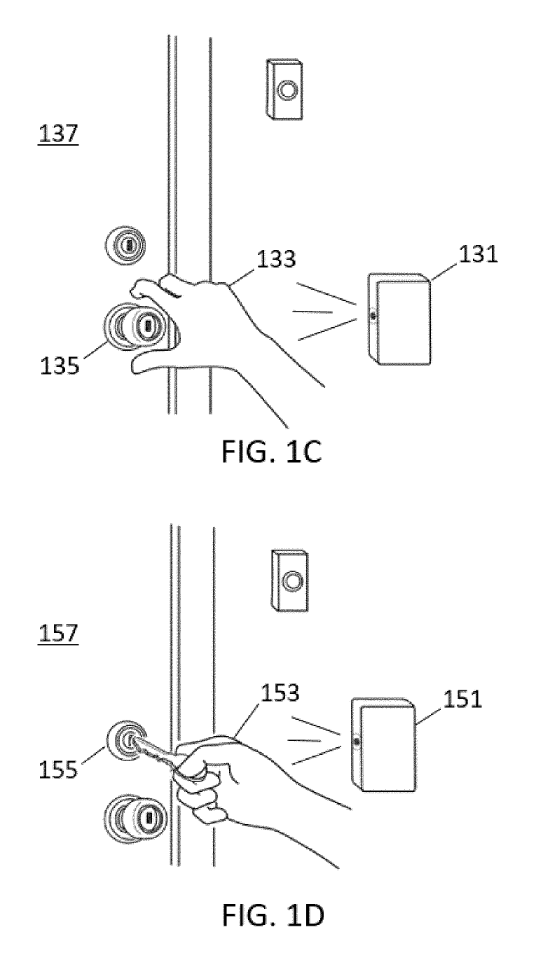

FIG. 1A depicts an example of the use of an embodiment of a legacy entry control monitor 101 which may be adapted and configured for responding to the operation by a user 103 of a legacy doorbell control 105, of the kind typically found in proximity to an entry door 106. As depicted schematically in FIG. 1B, a legacy entry control monitor 101 may include a sensor 107 for detecting a physical property affected by the action of the user in operating the legacy entry control. For example, in an embodiment wherein the legacy entry control of interest is a doorbell button, the sensor could detect, and encode in an output signal, motion or heat from the user's hand while the user depresses the doorbell button. The output of the sensor may be communicated 109 to an interpretation module 111 adapted and configured to distinguish sensor outputs corresponding to operation by users of a legacy entry control from other sensor outputs or states. Thus, for example, in an embodiment wherein the legacy entry control of interest is a doorbell button, the interpretation module could embody logic for classifying patterns of motion or heat as output by the sensor and distinguishing patterns corresponding to user operation of the doorbell from other patterns. The interpretation module may be adapted and configured to operate 113 a transmitter 115 to transmit a signal 117 when sensor output is detected that is interpreted to correspond to doorbell operation by a user. The sensor, interpretation module, and transmitter may be powered 119 by a power source 121. In embodiments, the signal transmitted by the transmitter may be received by a smart home system or device or component thereof such as, for example, a central controller or a dispatch unit, which may initiate or control an action in response to the signal, such as, for example, sending a notification to a smart phone, activating a camera or intercom, or activating an alarm.

In embodiments, a legacy entry control monitor may be adapted and configured to respond to the operation by a user of any legacy entry control of any type whose interoperability with a smart home system or component thereof is deemed useful for an application of interest. Thus for example in some embodiments as depicted in FIG. 1C, a legacy entry control monitor 131 may be adapted and configured to detect the operation by a user 133 of a legacy doorknob or door latch 135 of the kind typically employed to open a door 137. In some embodiments as depicted in FIG. 1D, a legacy entry control monitor 151 may be adapted and configured to detect the operation by a user 153 of a legacy lock or locking device 155, such as a deadbolt or entry lock, as commonly employed to secure a door 157 against unauthorized entry. In such embodiments the choice of sensor and the sensitivity, range, focus, and/or other properties of the sensor may be chosen as may be found operable for detecting and interpreting the particular user action corresponding to the type of legacy entry control for which the monitor is to be employed. Similarly, the components, connectivity, and logic of the interpretation module may be chosen as may be found operable for distinguishing sensor outputs and/or states corresponding to the particular user action of interest from other sensor outputs and/or states.

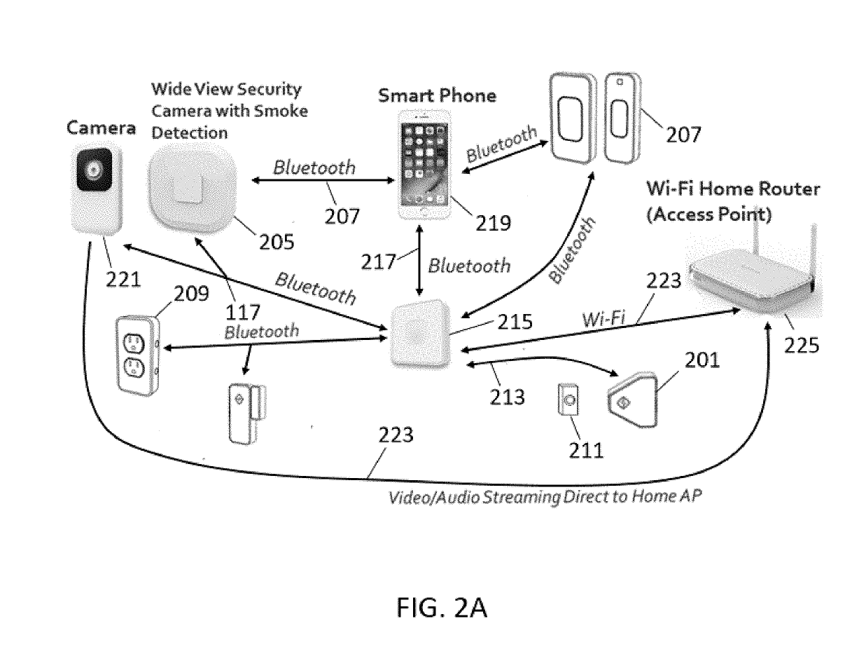

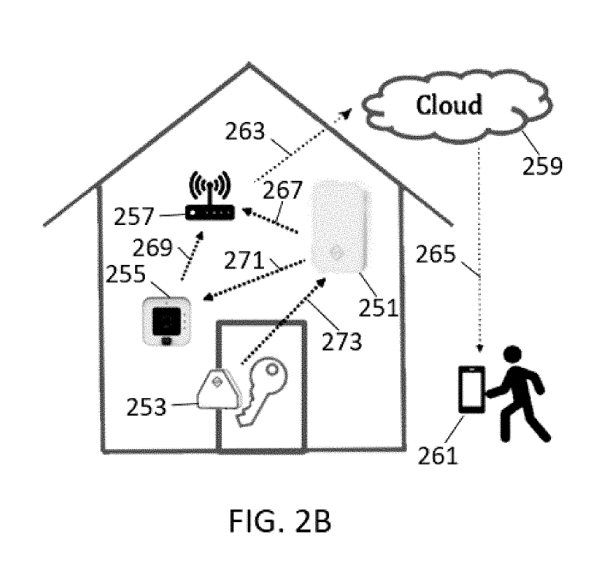

In embodiments as depicted in FIG. 2A, a legacy entry control monitor 201 may be part of and/or interact with a smart home system and/or other components thereof, which may include any other smart home and/or IoT components deemed useful for an application of interest, such as, for example, a security camera 205, or devices for operating and/or controlling switches 207, smart electrical receptacles 209, lights, appliances, HVAC equipment, thermostats, security sensors and/or alarms, etc., any of which may be adapted and configured to communicate in any operable manner using any protocol suitable for the functional objectives of the system. Thus, for example, a legacy control monitor could be configured to, upon recognition of an activation of a legacy control 211 by a user, transmit a signal 213 such as, for example, via a Bluetooth Low Energy (BLE) wireless connection, to a relaying or dispatch unit 215, from whence the signal could be relayed directly 217 to a smart phone 219, whereupon the user of the smart phone could operate the smart phone to transmit an activation signal 217 through the relaying device to a camera 221 to activate the camera and establish a video connection between the camera and the smart phone. In some embodiments, communication between devices may be accomplished in any manner operable to transmit and receive the desired signals, such as, for example by Bluetooth or BLE, Wi-Fi 223, or other wireless protocol based connections directly between devices, or by signals and/or connections relayed through other devices or access points 225 such as routers, hubs, or bridges, over local area or wide area networks, over telecom networks, and/or over internet connections. In some embodiments, so as to conserve power consumption by peripheral devices powered by battery or small photovoltaic panel, a recognition signal by a legacy control monitor may preferably be transmitted to a relay device via a relatively low power modality such as Bluetooth or BLE, and the relatively higher power consumption connection required, for example, for transmission of high definition video to and from a video camera may thus be activated only as needed, such as upon recognition by the legacy control monitor that a user has operated the legacy control, and may take place over a higher capacity communication channel such as a Wi-Fi connection.

FIG. 2B illustrates an exemplary use case in the context of an embodiment of a smart home system including a monitor consistent with the disclosure hereof. In this embodiment, the smart home system and its installation environment include a legacy entry control monitor for monitoring user operation of a doorbell button 253, and a camera unit 255, and a dispatch unit 251. A dispatch unit could be any device adapted and configured to receive a predetermined signal from a first device and in response thereto dispatch a signal to a second device; in embodiments, a dispatch unit could communicate with two or more devices by a wireless communication modality such as, for example, BLE, and/or could communicate with different devices by different communication modalities, such as, for example, communicating with a legacy control monitor and/or camera unit by BLE and with a wireless access point by Wi-Fi. A wireless Internet access point 257, such as, for example, an Internet-connected Wi-Fi router, provides access to the Internet 259. A user may interact with the system using a smart phone 261, with instructions relayed to the system through a connection 265 from the user's smart phone to the Internet, and thence to the dispatch unit by way of the wireless access point, and/or with data relayed from the system to the user through the wireless access point and the Internet, and/or with status and/or other message traffic relayed 267 by the dispatch unit to the wireless access point via a BLE, Bluetooth, or Wi-Fi connection and thence to the user. The connection from the user's smart phone with the Internet could, for example, be over a cellular network, or via a Wi-Fi connection. When the doorbell monitor 253 detects a condition indicating operation of the legacy doorbell button, it may transmit an alert message 273 to the dispatch unit. For example, in embodiments, the doorbell monitor 253 may be adapted and configured to transmit BLE advertisement packets on a predetermined advertisement interval, which may be received and monitored by the dispatch unit, and upon detecting a condition indicating operation of the legacy doorbell button, a subsequent advertisement packet may be modified to encode the alert, together with any other parameters found useful for an application. Upon receiving an alert message, the dispatch unit may transmit 271 an activation signal to the camera unit, whereupon the camera unit may begin transmitting video to be relayed to the user's smart phone for viewing using a suitable application. The video transmission could, for example, be made via a direct Wi-Fi communication with the user's smart phone, if within range, or could be transmitted by a Wi-Fi communication 269 to the wireless access point, thence 263 over the Internet to be relayed 265 to the user's smart phone.

In embodiments of a legacy control monitor wherein a BLE module is employed for wireless communication with other devices, the BLE module may be adapted and configured to transmit advertisement packets on a predetermined interval, which may be adjusted to achieve a desired power consumption level, with longer intervals providing reduced power consumption but at the cost of increased latency. Thus in some embodiments of a smart home peripheral device, such as a legacy control monitor, for a practicable balance of power conservation vs. latency, and depending on the demands of the application, where relatively fast response is needed the advertising interval may be set to between about 250 ms and about 350 ms; or between about 150 ms and about 250 ms; or between about 50 ms and about 150 ms; or between about 20 ms and about 50 ms; while in applications where a short delay in response is tolerable the advertising interval could be set to between about 350 ms and about 750 ms; or between about 750 ms and about 1.5 s; or between about 1.5 s and about 3 s; or between about 3 s and about 24 s.

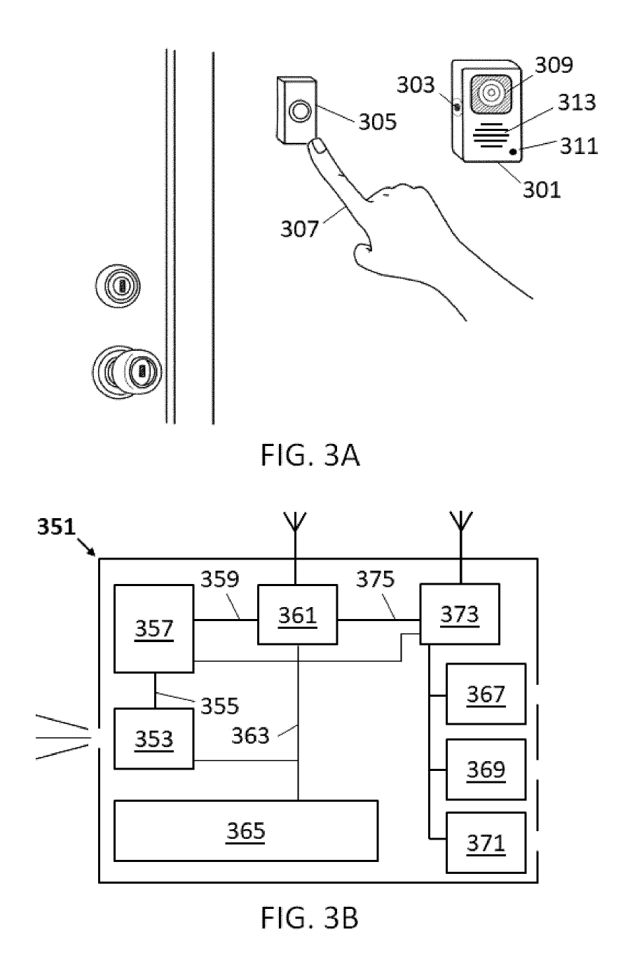

In some embodiments such as, for example, depicted in FIG. 3A, a legacy entry control monitor may be incorporated into and/or integrated with another device or component, and/or include additional components, such as, for example, to provide additional functionality within a single device or module. In embodiments, for example, a legacy control monitor 301 including a sensor 303 for sensing a physical property affected by the operation of a legacy control 305 by a user 307 may be incorporated with a remote video camera 309, microphone 311, and/or speaker 313 in a single housing with one or more wireless transmitters and/or receivers. Thus as depicted in FIG. 3B, a legacy entry control monitor 351 may include a sensor 353 for detecting a physical property affected by the action of the user in operating the legacy entry control, with the output of the sensor routed 355 to an interpretation module 357 adapted and configured to distinguish sensor outputs corresponding to operation by users of a legacy entry control from other sensor outputs or states. The interpretation module may be adapted and configured to operate 359 a low power transceiver 361 such as, for example, a Bluetooth or BLE transceiver, to transmit an alert signal when sensor output is detected that is interpreted to correspond to operation by a user of a legacy entry control of interest. The sensor, interpretation module, and transmitter may be powered 363 by a power source 365. Also provided may be one or more of a camera 367, a speaker 369, a microphone 371, or any other component found useful for an application of interest, whose input and/or output may be routed to a higher capacity transceiver 373 having a greater range and/or greater bandwidth than the low power transceiver, such as, for example, a Wi-Fi transceiver. In this way the alert signal from the low power transceiver may be received by the smart home system or a component thereof, and upon command by a user and/or in response to automated logic of the smart home system, a responsive signal may be returned via the low power transceiver to activate 375 the higher capacity transceiver to commence transmitting video from the camera and/or audio from the microphone, and/or to receive and emit audio via the speaker. Many alternative configurations are possible; in some embodiments, for example, the higher capacity transceiver could be activated directly by a signal or command from the interpretation module. In some embodiments, the monitor functionality and the functionality provided by the higher capacity transceiver, camera, speaker, and/or microphone could be disposed in separate devices or housings.

In embodiments, a smart home system may encompass and/or include any interoperating components, devices, and/or systems for automating and/or remotely controlling any of the appliances and/or devices commonly associated with homes and/or offices, such as, for example, lighting, sound systems, entertainment systems, and other electrical devices; security, intrusion, fire, and other alarm systems and devices; locks, doors, and physical security and entry systems and devices; heating, cooling, ventilation, air conditioning, and other environmental control systems and devices; irrigation and other plumbing related systems and devices; home, office, and/or kitchen appliances; control devices such as, for example, remote controls, smart phones, tablets, and/or other computing devices; communication devices such as, for example, routers, hubs, bridges, transmitters, and receivers; and any other systems, devices, and/or components now or in the future associated with smart home systems and/or “internet of things” devices and systems, as understood by persons of skill in the art. The installed environment of a smart home system may include any premises or environment in which the smart home system and its components are desired to operate. Thus a smart home system and/or any components or devices thereof may but may not necessarily be located entirely or partially in a dwelling; in embodiments, a smart home system and its environment could include systems and/or components located in whole or part in a home, apartment, or other dwelling, or in an office or other premises, a vehicle, or other location having a need for the functionality provided by a smart home system and its associated devices. A smart home system could be distributed over more than one such location. A smart home system and/or any components or devices thereof may or may not be adapted and configured for direct communication over the internet or over a wireless network. A smart home system may include devices and/or components having functions in addition to their function within the smart home system, such as, for example, smart phones, tablets, and computers.

Typically present in the installed environment of a smart home system there may be present a variety of “legacy” devices and controls that are not connected to or interoperable with the smart home system. In general, in embodiments, legacy controls and/devices may be or include any apparatus, devices, components, systems, and/or combinations thereof that are present within the environment of the smart home system, and which may not be compatible and/or operable to send and/or receive communications to and/or from the smart home system and/or its components. Often, legacy controls or devices may not be provided with interfaces suitable for interacting with other devices. In some embodiments legacy controls and/or devices may typically be or include conventional and/or non-automated devices and components such as any of the ordinary non-network-enabled electrical, security, entry, HVAC, plumbing, and other devices, components, and appliances commonly found in non-automated homes or offices. In some embodiments legacy controls and/or devices may typically be or include the conventional and/or non-automated devices and components already present in a home or office environment prior to the installation of a smart home or IoT system. In some embodiments legacy controls or devices could include controls or devices that lack any interfacing modality with which a smart home system is operable to connect. In some embodiments, a legacy entry control could include any entry control to which a legacy control monitor is not electrically or physically connected. In some embodiments, a legacy entry control could include any entry control that is not operable to emit a communication or signal that the smart home system of interest is operable to receive. In embodiments, a legacy entry control may include any legacy control associated with entry or exit from a dwelling or other installed environment of a smart home system, and not operable to communicate electronically with the smart home system, such as, for example, a doorbell button or other doorbell switch or control; a doorknob, knobset, or door or window latch or opening or closing mechanism; or a lock, deadbolt, or other locking mechanism.

In embodiments according to the disclosure hereof, a “user” may refer to or include any person or agent interacting in an intended manner with a smart home or IoT system or component thereof. In embodiments according to the disclosure hereof, for clarity and to distinguish from a user who is merely a visitor, an “owner” may refer to or include a person who has the right to control a smart home system or IoT system and/or the premises in which it is installed, or who is acting under the authority or permission of such a person; an owner would not necessarily have a legal ownership interest in the premises, and could, for example, include a lessee or a family member or employee of an owner.

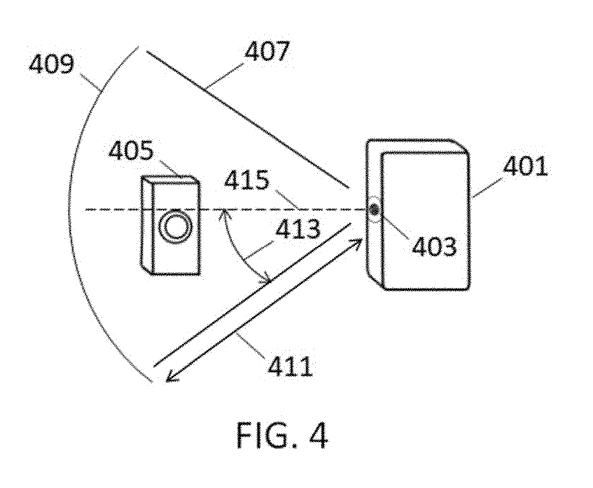

In embodiments, a sensor for incorporation in a monitor may include any one or more sensing devices or components operable to sense a physical property capable of being affected by user action in operating a legacy control. Examples of sensors could include a passive infrared sensor; an active infrared sensor, which may be accompanied by or used in the presence of an infrared source; a microwave sensor; a photoelectric sensor; a camera; a charge-coupled device; a capacitance sensor; an accelerometer; a gyroscopic sensor or laser gyroscope; a vibration sensor; a microphone or other acoustic detector. In some embodiments a sensor could include a separate component for attachment in relation to a legacy control to provide additional sensor input, such as, for example, a reflector or light source. In some embodiments wherein a sensor is mounted within a housing, there may be provided an aperture in the housing so as to avoid blocking the reception of the sensor. A sensor incorporated in a monitor may have or be configured to have a sensing envelope, that is, a spatial region relative to the sensor wherein the sensor has relatively high sensitivity to alterations occurring within the region of a physical property to which the sensor is sensitive and relatively lower sensitivity to alterations in the physical property occurring outside the region. As illustrated in FIG. 4, in some embodiments of a monitor 401, a sensor 403 may preferably be configured, and the monitor positioned relative to a legacy control 405, whereby the sensitivity of the sensor to operation by a user of the legacy control occurring within a sensing envelope having boundaries 407, 409 approximately defined by an envelope distance 411 from the sensor of about 10 cm, or about 12 cm, or about 15 cm, or about 20 cm, or about 30 cm, or about 40 cm, or about 50 cm, or about 75 cm, or about 1.0 m, and by an envelope angle 413 from a central axis 415 of the sensor of about 10°, or about 20°, or about 30°, or about 45°, or about 60°, is greater than the sensitivity of the sensor to operation by a user of a legacy control beyond a distance greater than the envelope distance by more than about 0%, or about 10%, or about 25%, or about 50%, or about 100%, or beyond an angle from the central axis of the sensor exceeding the envelope angle by more than about 10°, or about 20°, or about 30°, or about 45°. In some embodiments there may be provided components such as, for example, lenses or wave guides, and/or other components such as focusing, alignment, or collimating components, for establishing a desired sensing envelope.

In embodiments, an interpretation module may include any component or device or combination thereof operable to receive a signal from a sensor and classify the signal as corresponding or not to a sensor signal produced upon operation of a legacy control by a user. In some embodiments an interpretation module could include a relatively simple logic circuit for classifying sensor signals on the basis of one, two, three, or more characteristics. In some embodiments an interpretation module could include a classifier implemented via a microprocessor or in hardware. In some embodiments, an interpretation module could include a machine learning based classifier implemented in hardware or software and operable to be trained to recognize sensor signals as corresponding or not to user operation of a legacy control.

In embodiments, the components of a monitor may be assembled and/or constructed in any manner and using any additional components and/or fabrication technology found advantageous for an application of interest. In some typical embodiments, a sensor and its related circuitry could be disposed on a printed circuit board mounted in a housing with a sensor in alignment with any aperture or focusing components if present. An interpretation module, transceiver, and/or power source could be implemented as circuitry on the same printed circuit board, or as a separate module mounted thereto or connected therewith in any operable manner. In some embodiments a sensor, interpretation module, transceiver, or other component(s) may be implemented in whole or part as integrated circuits. In some embodiments components may be integrated in a single module or apparatus, optionally with sharing of some elements, in any manner operable for the intended functionality; for example, a sensor and interpretation module could be integrated in a single module or component using a shared power source.

In embodiments, a monitor may be installable whereby no alteration of a legacy control and/or of the interaction of a legacy control with other components is required for installation and operation of the monitor. In embodiments, a monitor may be user-installable, which could be, for example, by an ordinary consumer without the use of tools, or requiring only commonly available tools such as a screwdriver or scissors, and/or without training or experience in the installation of consumer electronics. In embodiments, a monitor may be removably installable, whereby the monitor may be uninstalled and/or removed from its installation site without damage to the monitor or to the installation site and/or in condition for reuse at another location if desired. In embodiments, a monitor, such as, for example, a legacy entry control monitor, may include a mounting and/or mounting components such as one or more brackets or holders, or may be disposed in a housing adapted for mounting, or may be adapted for mounting in any other operable manner. In some embodiments, a monitor, such as, for example, a legacy entry control monitor, may be mounted to a suitable surface using an adhesive or tape, such as, for example, 3M Command tape, or directly using a fastener such as one or more screws, or by engagement with a bracket mounted to a structure using an adhesive, tape, fastener, or other attachment.

In embodiments, a monitor may include one or more controls, such as buttons or touch screens, for use in operating the monitor or providing desired inputs. In embodiments, a monitor may be integrated with another smart home device. Particularly in embodiments intended for outdoor installation, a monitor may preferably be housed in a weatherproof, waterproof, or water resistant housing.

In embodiments, a monitor may be a wire-free device, requiring no wired or other physical external connections for power or data input or output in normal operation. In embodiments, a monitor may be powered by one or more batteries and/or other self-contained power sources. In embodiments, a wire-free monitor may be adapted to operate without battery replacement or other maintenance for at least about one year, or about 15 months, or about 18 months, or about two years.

### EXAMPLES

### Example 1

A legacy control monitor for detecting operation of a legacy doorbell button by a user was constructed employing a passive infrared motion sensor configured to a 30 degree field of view and maximum 10 cm range, for installation immediately adjacent to a legacy doorbell button generally as shown in FIG. 1 for use in a context generally as illustrated in FIG. 2B. The device employed a Nordic nRF52832 Bluetooth Low Energy (BLE) chipset for wireless communication with other smart home devices, and is powered by 2 1.5V AAA batteries. In operation, the Nordic nRF52832 is configured to transmit advertisement packets at an advertising interval of 330 ms. The microcontroller of the Nordic nRF52832 is used to provide interpretation module functionality, and responds to sensor activation within the 30 degree/10 cm sensing envelope by wirelessly transmitting via BLE an alert signal consisting of a flag set in the next advertisement packet transmitted. The advertisement packet is received by a dispatch unit, which then transmits a signal to a camera unit to begin transmitting video. The microcontroller of the Nordic nRF52832 includes an integrated ADC which is used for monitoring the supply voltage and detecting and reporting a low battery condition.

### Other Embodiments

In embodiments, provided herein is a legacy control monitor for detecting operation by a user of a legacy entry control, wherein the legacy control monitor includes a sensor operable to detect a physical property affected by the action of the user operating the legacy entry control and to produce a signal encoding a characteristic of the physical property detected; an interpretation module configured to receive a signal produced by the sensor and produce an alert response if the signal corresponds to an operation of the legacy entry control by a user; a transmitter configured to detect an output of the interpretation module and upon receiving an alert response, transmit an alert signal; and a power source for providing electrical power to the sensor, interpretation module, and transmitter.

In embodiments of a legacy control monitor, a transmitter may include a wireless transceiver adapted to transmit via a Bluetooth Low Energy (BLE) protocol. In embodiments of a legacy control monitor, an interpretation module may be operable to distinguish a signal corresponding to an operation of the legacy entry control by a user from a signal corresponding to sensor output not corresponding to an operation of the legacy entry control by a user and occurring within the sensing envelope of the legacy control monitor.

In embodiments there is provided a system including a legacy control monitor and a camera module, wherein the camera module is configured to receive an activation signal upon detection by the legacy control monitor of operation of the legacy entry control by a user, and to thereupon transmit video.

In embodiments, a legacy control monitor may be adapted and configured to detect operation of any kind of legacy control, which could be a legacy entry control. Examples of legacy entry controls could include a doorbell button, a doorknob or latch, and a lock or locking device.

In embodiments of a legacy control monitor, there may be provided a housing in which a sensor and interpretation module are disposed, and there may be provided one or more user-installable mounting components for securing the legacy control monitor to a structure.

In embodiments of a legacy control monitor, a sensor could include a passive infrared sensor. In embodiments, the sensing envelope of a legacy control monitor could include a region within about 12 cm outward from the sensor and within an angle of about 15 degrees from the central axis of the sensor.

In embodiments, there is provided a smart home system, including a legacy control monitor, a dispatch unit, and at least one smart home peripheral device, wherein the dispatch unit is configured and adapted to receive an alert signal from a legacy control monitor and control a smart home peripheral device in response thereto. In such a smart home system, a smart home peripheral device could be a camera module, and the dispatch unit could be adapted and configured to receive an alert signal transmitted by the legacy control monitor and in response thereto transmit an activation signal by a Bluetooth Low Energy protocol to the camera module, with the camera module being adapted and configured to, upon receiving the activation signal, wirelessly transmit video via a Wi-Fi protocol.

In embodiments, there is provided a method of using a monitor according to claim 1, including mounting the monitor whereby a legacy entry control is within the sensing envelope of the monitor, supplying power to the monitor, and causing another smart home device to register the presence of the monitor.

In embodiments, there is provided a method of communicating a user intention to a smart home system including a legacy control monitor, the method including operating a legacy control, such as for example, a legacy entry control, by user action within the sensing envelope of the legacy control monitor.

In embodiments, there is provided a kit, including a legacy control monitor and a camera unit.

In embodiments, there is provided a method of installing a legacy control monitor, including securing the monitor to a structure in a position whereby the legacy control is within the sensing envelope of the sensor, wherein installing the monitor does not entail any physical alteration of or physical connection to the legacy control and does not alter the normal operation of the legacy control.

In embodiments, there is provided a method of producing a response by a smart home system to operation by a user of a legacy control, such as, for example, a legacy entry control, the method including: sensing a physical property affected by the action of the user operating the legacy entry control and encoding a characteristic of the physical property in a signal; interpreting the signal by determining therefrom whether the signal corresponds to an operation of the legacy entry control by a user; and in the event that the signal is determined to correspond to an operation of the legacy entry control by a user, conveying an alert signal to a component of the smart home system.

In embodiments, there is provided an interfacing device for interfacing a non-compatible device or control with a smart home system, the interfacing device including: a sensing module operable to detect a physical property affected by the operation of the non-compatible device or control and produce a sensing signal encoding a characteristic of the physical property detected; an interpretation module configured to receive and process the sensing signal and upon detecting a signal corresponding to the operation of the non-compatible device or control produce a recognition signal; and a communication module adapted and configured to receive the recognition signal and thereupon communicate a signal to the smart home system or a component thereof.

### Concluding Matter

The disclosed methods, systems, devices, apparatus, compositions, articles of manufacture, and improvements thereof have been explained above with reference to several embodiments. Other embodiments will be apparent to those skilled in the art in light of this disclosure. Certain aspects of the described subject matter may readily be implemented using configurations other than those described in the embodiments above, or in conjunction with elements other than those described above. For example, different components, algorithms and/or logic circuits, perhaps more complex than those described herein, may be used. Although many of the examples and embodiments described herein relate to monitor devices for detection of the operation of legacy entry controls, the disclosed principles, methods, and components may also be readily adapted to any user controllable fixtures having physically operable controls or user-operable controls or that otherwise are intended or adapted to interact with or supply power or signals to devices or appliances of any kind.

Further, it should also be appreciated that the described subject matter can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the disclosed subject matter is described with reference to specific embodiments thereof, but those skilled in the art will recognize that the invention is not limited thereto. Various features and aspects of the above-described subject matter may be used individually or jointly. Further, the described subject matter can be utilized in any number of environments and applications beyond those described herein without departing from the broader spirit and scope of the specification. The specification and drawings are, accordingly, to be regarded as illustrative rather than restrictive.

In the foregoing disclosure, specific functions may be attributed to specific components or modules. It will be apparent that the functional boundaries between components or modules are substantially artificial; functionality attributed to two or more modules or components could equivalently be combined in a single module or component, and functionality attributed to a single module or component could equivalently be divided between two or more modules or components. The disclosure hereof extends to all such equivalent arrangements.

Except as otherwise explicitly stated, an embodiment of an apparatus or object is described herein in an orientation as in normal use as described herein, with “lower side” referring to the portion generally oriented downward, and “upper side” referring to the generally upwardly oriented portion. “Upward” and “downward” refer to the upward and downward directions relative to the apparatus or object when oriented as in normal use. “Lateral” and “horizontal” refer to the spatial dimensions generally perpendicular to the “upward” and “downward” directions, with the apparatus or object oriented as in normal use. “Vertical” refers to the generally upward/downward direction with the apparatus or object oriented as in normal use. “Inward” and “outward” refer respectively to lateral directions generally toward and away from a generally vertical axis passing through the centroid or center of mass of the apparatus or object. Except as otherwise specifically stated or required by context, directional terms are not intended to be limiting or to imply that the apparatus or object must be used in any particular position or orientation.

In embodiments, components and/or substructures described herein as having fixed positions relative one to another may be held in position in any manner operable to maintain the specified positions under conditions of normal use as described herein, such as, by way of example only, by the use of mechanical fasteners such as bolts, screws, nuts, or rivets; by heat, such as, for example, welding, brazing, or soldering; by an adhesive; by incremental deposition, such as, for example, by 3D printing; and/or by forming a component integrally or as a single piece with another component. In embodiments, components and/or substructures described herein as having movable positions relative one to another may be constrained in position in any manner operable to constrain the components and/or substructures within the specified ranges of positions under conditions of normal use as described herein, such as, by way of example only, by the use of mechanical fasteners such as hinges, sliders, tracks, followers, pivots, bearings, and/or flexible components. Unless otherwise specifically stated or required by context, mounting and/or affixation may be permanent or removable or removable and replaceable, as deemed useful for an application of interest.

For clarity and to ensure completeness, certain of the aspects and/or embodiments disclosed herein may be overlapping in scope, described repetitively, or represent recitals of the same or equivalent elements or combinations expressed in alternative language. It will be apparent that the choice of particular phraseology and/or of particular aspects or elements to assert as claims involves many complex technical and legal considerations, and no inference should be drawn that alternative descriptions of a particular element or combination in this written description necessarily do or do not encompass different subject matter; except where context otherwise requires, each described aspect or element should be interpreted according to its own description.

It is intended that this specification be interpreted in accordance with the normal principles of English grammar and that words and phrases be given their ordinary English meaning as understood by persons of skill in the pertinent arts except as otherwise explicitly stated. If a word, term, or phrase is intended to be further characterized, specified, or narrowed in some way, then additional adjectives, modifiers, or descriptive text have been included in accordance with the normal principles of English grammar. It is intended that the meanings of words, terms, or phrases should not be modified or characterized in a manner differing from their ordinary English meaning as understood by persons of skill in the relevant arts except on the basis of adjectives, modifiers, or descriptive text that is explicitly present.

Except as otherwise explicitly stated, terms used in this specification, including terms used in the claims and drawings, are intended as “open” terms. That is, for example, the words “including” and “comprising” should be interpreted to mean “including but not limited to,” the word “having” should be interpreted to mean “having at least,” the word “includes” should be interpreted to mean “includes but is not limited to,” the phrases “for example” or “including by way of example” should be interpreted as signifying that the example(s) given are non-exhaustive and other examples could be given, and other similar words and phrases should be given similar non-exclusive meanings. Except as explicitly stated, ordinals used as adjectives (e.g. “first object”, “second object”, etc.) in this specification, including claims and drawing figures, are intended merely to differentiate and do not imply that any particular ordering is required. Thus, for example, unless otherwise explicitly stated, “first measurement” and “second measurement” do not imply that the first measurement necessarily takes place before the second measurement, but merely that they are distinct measurements.

In the written description and appended claims, the indefinite articles “a” and/or “an” are intended to mean “at least one” or “one or more” except where expressly stated otherwise or where the enabling disclosure requires otherwise. The word “or” as used herein is intended to mean “and/or”, except where it is expressly accompanied by the word “either”, as in “either A or B”. Applicants are aware of the provisions of 35 U.S.C. § 112(f). The use of the words “function,” “means” or “step” in the written description, drawings, or claims herein is not intended to invoke the provisions of 35 U.S.C. § 112(f), to define the invention. To the contrary, if the provisions of 35 U.S.C. § 112(f) are sought to be invoked, the claims will expressly include one of the exact phrases “means for performing the function of” or “step for performing the function of”. Moreover, even if the provisions of 35 U.S.C. § 112(f) are explicitly invoked to define a claimed invention, it is intended that the claims not be limited only to the specific structure, material or acts that are described in the preferred embodiments, but in addition, extend to any and all structures, materials or acts that perform the claimed function as described in alternative embodiments or forms of the invention, or that are well known present or later-developed equivalent structures, material or acts for performing the claimed function.

In the foregoing description, various details, specific aspects, embodiments, and examples have been described in order to illustrate and explain the subject matter, to provide a thorough understanding of the various aspects, to enable persons skilled in the pertinent arts to practice the described subject matter. These details, specific aspects, embodiments, and examples are not intended to be limiting; rather, it will be apparent to persons of skill in the relevant arts that, based upon the teachings herein, various changes, substitutions, modifications, rearrangements, may be made and various aspects, components, or steps may be omitted or added, without departing from the subject matter described herein and its broader aspects. Except as otherwise expressly stated or where aspects or features are inherently mutually exclusive, aspects and features of any embodiment described herein may be combined with aspects and features of any one or more other embodiments. Titles, headings, and subheadings herein are intended merely as a convenience for locating content, and do not limit or otherwise affect the interpretation of the content of the disclosure. The appended claims are intended to encompass within their scope any and all changes, substitutions, modifications, rearrangements, combinations of aspects or features, additions, and omissions that are within the spirit and scope of the subject matter as described herein and/or within the knowledge of a person of skill in the art. The scope of the invention is defined by the claims, and is not limited by or to the particular embodiments or aspects chosen for detailed exposition in the foregoing description, but rather extends to all embodiments or aspects as defined by the claims, as well as any equivalents of such embodiments or aspects, whether currently known or developed in the future.

What is claimed is:

1. A monitor for detecting operation by a user of a legacy entry control, the monitor comprising:
a sensor operable to detect a physical property affected by the action of the user operating the legacy entry control and to produce a signal encoding a characteristic of the physical property detected;
an interpretation module configured to receive a signal produced by the sensor and produce an alert response if the signal corresponds to an operation of the legacy entry control by a user;
a transmitter configured to detect an output of the interpretation module and upon receiving an alert response, transmit an alert signal; and
a power source for providing electrical power to the sensor, interpretation module, and transmitter.

2. The monitor of claim 1, wherein the transmitter comprises a wireless transceiver adapted to transmit via a Bluetooth Low Energy (BLE) protocol.

3. The monitor of claim 1, wherein the interpretation module is operable to distinguish a signal corresponding to an operation of the legacy entry control by a user from a signal corresponding to sensor output not corresponding to an operation of the legacy entry control by a user and occurring within the sensing envelope of the monitor.

4. A system comprising the monitor of claim 1 and a camera module, wherein the camera module is configured to receive an activation signal upon detection by the monitor of operation of the legacy entry control by a user, and to thereupon transmit video.

5. The monitor of claim 1, wherein the legacy entry control comprises a doorbell button.

6. The monitor of claim 1, wherein the legacy entry control comprises a doorknob or latch.

7. The monitor of claim 1, wherein the legacy entry control comprises a lock or locking device.

8. The monitor of claim 1, further comprising a housing in which the sensor and interpretation module are disposed, and a user-installable mounting for securing the monitor to a structure.

9. The monitor of claim 1, wherein the sensor comprises a passive infrared sensor.

10. The monitor of claim 1, wherein the sensing envelope of the monitor comprises a region within about 12 cm outward from the sensor and within an angle of about 15 degrees from the central axis of the sensor.

11. A smart home system, comprising a monitor according to claim 1, a dispatch unit, and at least one smart home peripheral device, wherein the dispatch unit is configured and adapted to receive the alert signal and control the at least one smart home peripheral device in response thereto.

12. A smart home system, comprising a monitor according to claim 1, a dispatch unit, and a camera module, wherein the dispatch unit is adapted and configured to receive an alert signal transmitted by the monitor and in response thereto transmit an activation signal by a Bluetooth Low Energy protocol to the camera module, and the camera module is adapted and configured to, upon receiving the activation signal, wirelessly transmit video via a Wi-Fi protocol.

13. A method of using a monitor according to claim 1, comprising mounting the monitor in a position whereby a legacy entry control is within the sensing envelope of the monitor, supplying power to the monitor, and causing another smart home device to register the presence of the monitor.

14. A method of communicating a user intention to a smart home system comprising a monitor according to claim 1, the method comprising operating a legacy entry control by user action within the sensing envelope of the monitor.

15. A kit, comprising a monitor according to claim 1 and a camera unit.

16. A method of installing a monitor according to claim 1, comprising securing the monitor to a structure in a position whereby the legacy entry control is within the sensing envelope of the sensor, wherein installing the monitor does not comprise any physical alteration of or physical connection to the legacy entry control and does not alter the normal operation of the legacy entry control.

17. A method of producing a response by a smart home system to operation by a user of a legacy entry control, the method comprising:
sensing a physical property affected by the action of the user operating the legacy entry control and encoding a characteristic of the physical property in a signal;
determining whether the signal corresponds to an operation of the legacy entry control by a user; and
in the event that the signal is determined to correspond to an operation of the legacy entry control by a user, conveying an alert signal to a component of the smart home system.

18. An interfacing device for interfacing a non-compatible device or control with a smart home system, the interfacing device comprising:
a sensing module operable to detect a physical property affected by the operation of the non-compatible device or control and produce a sensing signal encoding a characteristic of the physical property detected;
an interpretation module configured to receive and process the sensing signal and upon detecting a signal corresponding to the operation of the non-compatible device or control produce a recognition signal; and
a communication module adapted and configured to receive the recognition signal and thereupon communicate a signal to the smart home system or a component thereof.
